(19) United States
(12) Patent Application Publication
(10) Pub. No.: US 2007/0178261 A1
(43) Pub. Date: Aug. 2, 2007

(54) Paper envelope having an integrated magnetic recording medium

(76) Inventors: Avery Levy, Harrison, NY (US); Zory Ginzburg, New York, NY (US)

Correspondence Address: FULBRIGHT AND JAWORSKI LLP, 555 S. FLOWER STREET, 41ST FLOOR, LOS ANGELES, CA, 90071, US

(21) Appl. No.: 11/341,980

(22) Filed: Jan. 27, 2006

(51) Int. Cl. B32B 27/10; B32B 15/00

(52) U.S. Cl. 428/34.2; 428/692.1; 428/537.5

(57) ABSTRACT

A paper envelope which includes as an integral part thereof, a magnetic recording medium which is disposed in a plurality of interconnected cells. The cells containing the magnetizable material to form the magnetic recording medium are covered by an additional layer of paper to protect and/or retain the magnetizable particles in place.

### BACKGROUND OF THE INVENTION

This invention relates generally to paper envelopes and more particularly, to a paper envelope which includes as an integral part thereof magnetic recording medium.

A very large number of paper envelopes are used each day in conveyance of written and printed materials as well as other objects and the like from place to place through the world's postal service and well as through couriers and the like. In many instances, it is the desire of the sender of the information contained within such paper envelopes to have means by which both the sender and receiver can track the envelope and also be assured of the integrity of the contents of the envelope. To this extent, many tracking and scanning systems have been developed which through the use of optical code readers information in the form of barcodes and the like may be scanned and read for purposes of tracking. Security of the contents of the envelope has for the most part been relegated to visible means provided for detection of tampering, opening or the like.

The advent of magnetic technology, and its development to the extent that has occurred to date, provides the ability to incorporate magnetic recording medium into a paper envelope to provide an envelope which can be uniquely coded, traceable, trackable and can provide means for ensuring integrity and security of the contents of the envelope.

### BRIEF SUMMARY OF THE INVENTION

The present invention provides a paper stock envelope having a body portion and a flap foldable over the body. The envelope includes a magnetic recording medium extending over at least a portion of the envelope with the magnetic recording medium being retained within a plurality of interconnected cells formed as an integral part of the paper from which the envelope is formed. The term “paper stock” as used herein includes paper made from mechanical, chemical or semi-chemical pulp.

In accordance with a more specific aspect of the present invention, the magnetic recording medium is covered by an additional sheet of paper which is placed over the plurality of interconnected cells and secured to the paper stock from which the envelope is formed.

In accordance with a further aspect of the present invention the magnetic recording medium may be contained within discreet portions of the envelope. The discreet portions may be measured and specifically placed on the envelope or alternatively, may be discreet portions which are randomly disposed on the envelope.

In accordance with yet a further aspect of the present invention, a security function may be provided between the flap and the body portion of the envelope wherein discreet information may be recorded within the magnetic recording medium so that the information recorded on the magnetic recording medium contained on the flap which overlaps the magnetic recording medium on the body is destroyed or otherwise altered if the flap is opened.

### BRIEF DESCRIPTION OF THE DRAWINGS

FIG. 1 is a schematic representation of an envelope formed in accordance with the principles of the present invention;

FIG. 2 is a plan view of a blank from which an envelope constructed in accordance with the present invention may be formed;

FIG. 3 is a cross-sectional view taken about the lines 3-3 of FIG. 2 showing the manner in which a magnetic recording medium is provided in the envelope;

FIG. 4 is a schematic representation of the manner in which the cells shown in FIG. 3 are formed within the paper; and

FIG. 5 is a schematic representation of the security feature between the flap and the body of the envelope of the present invention.

### DETAILED DESCRIPTION OF THE INVENTION

When information is being transmitted in a manner such that the contents of the information is to be maintained confidential and secured, the persons involved, in many instances, still prefer the utilization of paper as the means for doing so. When paper is utilized, it is desirable to have a means whereby the documents being transmitted can be easily tracked and followed while they are in transit and to also be able to assure that the integrity of the contents has not been destroyed or tampered with in any way. It is thus desirable to have a container for the documents being transmitted, such as an envelope, which provides means for encrypting the envelope to allow the envelope to be easily tracked. It is also desirable that the means provided for recording information regarding the contents of the envelope, such as the destination, type of contents, sender, and the like cannot be visibly ascertained by viewing the envelope. Therefore, the recording medium contained in the envelope must be integrated therein in such a manner that there are no visually perceived clues as to the existence or location of the recording medium. It is also important that the information which is recorded in the recording medium may be accessable by traditional magnetic reading heads so that the information may be utilized for tracking purposes such, for example, as being able to transmit that information quickly over the worldwide web to various interested parties.

Referring now more particularly to FIG. 1, there is shown one form of an envelope constructed in accordance with the present invention. The envelope 10 includes a body portion 12 and a flap 14 which is designed to fold over the body portion 12 and be sealed thereto with an adhesive which is disposed on the underside of the flap 14 as is well known in the prior art. In accordance with the principles of the present invention, either the body portion 12 or the flap 14 or both contain a magnetic recording medium extending over at least a portion thereof. In FIG. 1 the magnetic recording medium is schematically illustrated as being randomly disposed about the body 12 of the envelope 10 as is illustrated at 16, 18 and 20. Alternatively, the magnetic recording medium may be randomly disposed on the flap as shown at 22 and 24. It should be understood by those skilled in the art that although in FIG. 1 the randomly disposed magnetic recording medium 16 through 24 is illustrated graphically by graphic outlines, that in the construction of the envelope, as will described more fully below, the randomly disposed portions of magnetic recording medium are in fact not visible to the naked eye but rather are concealed by the integral construction of the paper stock from which the envelope is formed.

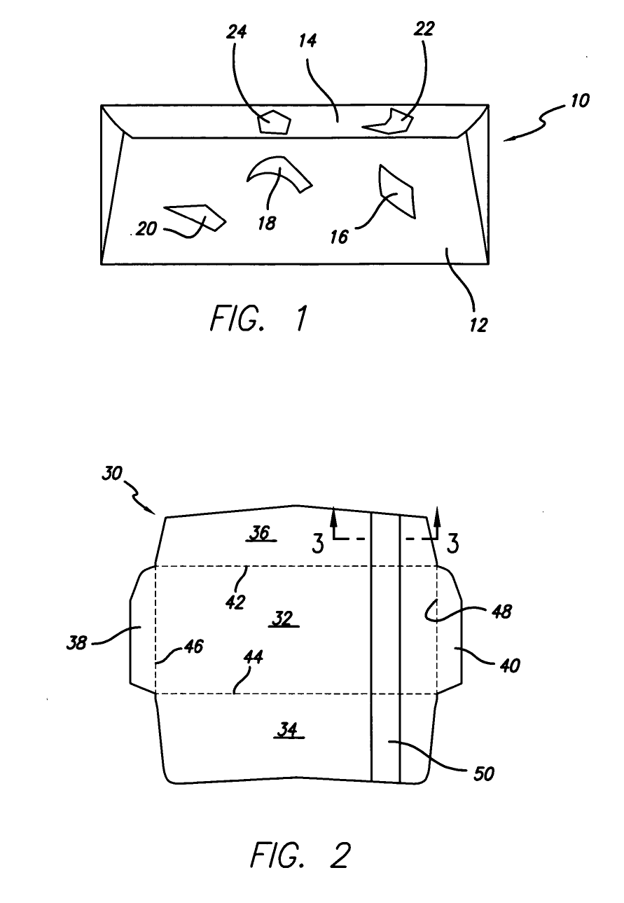

Referring now more specifically to FIG. 2, there is illustrated a blank 30 from which an envelope of the type illustrated in FIG. 1 may be formed. As is therein shown, the blank 30 includes a front panel area 32, a back panel area 34, a sealing flap 36, and side flaps 38 and 40. The front panel is defined by a top fold line 42 and a bottom fold line 44 as well as side fold lines 46 and 48. The front panel is defined by the common fold line 44 between the front panel 32 and the back panel 34. The sealing flap 36 is defined by the common fold line 42 between the front panel 32 and the sealing flap 36. The side flaps 38 and 40 are defined by the common fold lines 46 and 48 between the front panel 32 and the side flaps 38 and 40, respectively. As is well known in the envelope manufacturing art, the side flaps 38 and 40 are folded inwardly as is viewed in FIG. 2 along the fold lines 46 and 48 with the back panel 34 folded upwardly along the fold line 44 thereover, and the combination secured by an appropriate adhesive provided along the outer side edges of the back panel 34. In addition, a typical adhesive is provided along the upper outer edge of the sealing flap 36 so that when the contents as desired are placed within the envelope, the sealing flap 36 may be folded along the fold line 42 and sealed to the back panel 34.

In accordance with the principles of the present invention, there is provided a magnetic recording medium 50 which is contained in a measured and specifically placed portion of the envelope. This measured and specifically placed portion may for example be a predetermined distance from one outer edge of the envelope such as is defined by the fold line 48. Alternatively, the magnetic recording medium strip or portion could be positioned at any other portion of the envelope as may be desired or dictated by equipment such as magnetic write and read heads.

The recording medium 50 as illustrated in FIG. 2 is continuous but alternatively it may be broken into one or more sections along the body and flaps of the envelope but at the same time would be measured and specifically placed on the envelope.

As was the case with the randomly disposed portions of magnetic recording medium as illustrated in FIG. 1 and as above described, although the strip of magnetic recording medium 50 as shown in FIG. 2 is graphically illustrated schematically, it should be recognized that the magnetic recording medium strip cannot be detected visually in an unaided manner by merely observing the envelope surface. The magnetic recording medium, whether it be a continuous strip 50, a strip which is broken into sections, or the randomly disposed portions, may be utilized to receive recorded information of any type desired by the sender or mutually between the sender and receiver. Such information can be digitally or analog encrypted and relate to the sender, the receiver, the contents, tracking information or the like. This information would be recorded on the magnetic recording medium, either as randomly disposed or as measured and specifically placed through the utilization of a magnetic recording head of any type known to the prior art. Where the recording or write head is used in conjunction with an envelope having the magnetic recording medium contained in a measured and specifically placed portion as illustrated in FIG. 2 the magnetic write head can be pre-positioned to record the desired information in analog form or digitally on the magnetic recording medium 50. When an envelope having the randomly disposed portions of magnetic recording medium is used, for example, as illustrated in FIG. 1, the magnetic write head mechanism would also include a sensor so that as the envelope is positioned and moved through the write head mechanism, the write head can be automatically positioned to write the information that may be desired upon the discrete portions, such as those illustrated at 16 through 24 in FIG. 1. Obviously, when the contents of the magnetic recording medium is to be read, a similar sensor mechanism must be utilized to position the read head to detect and decipher the information which has been recorded upon the randomly disposed magnetic recording medium. The sensor mechanisms and read-write heads are well known in the prior art and thus detailed description or illustration thereof are not deemed required for the purposes of the description of this invention.

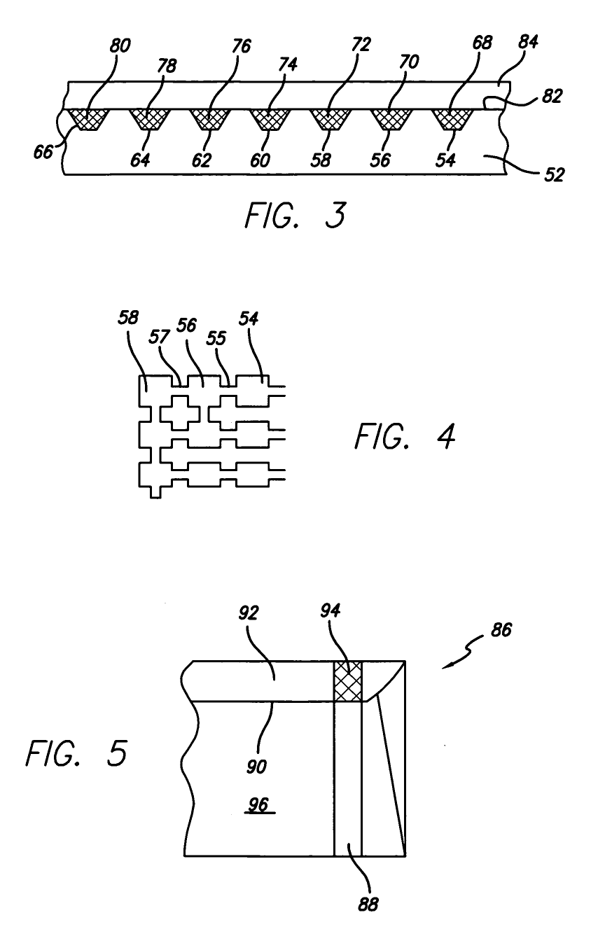

As above indicated, the magnetic recording medium is integrated into the paper stock from which the envelope of the present invention is constructed. A preferred method of making the paper stock is disclosed in co-pending patent application Ser. No. ______ filed concurrently herewith by the same inventors and entitled: Paper Having Discrete Regions of Ferromagnetic Material and Process of Making the Same. One form which the recording medium may take is illustrated in FIG. 3 to which reference is hereby made. As is therein shown, there is provided a base layer of paper stock 52 which has formed therein a plurality of depressions, indentations or cells 54 through 66. These depressions, indentations or cells may be formed in any manner desired in accordance with the manufacture of paper. For example, the cells may be formed in a manner which is taught in U.S. Pat. No. 6,911,115 which by this reference is incorporated herein. As is taught therein, the cells or indentations or depressions 54 through 66 are formed by providing a wire for use during the wet stage of the paper making process with a set of masks suitable for creating the cells 34 through 66 in the thickness of the paper. The set of masks serves to obtain the desire depressions, indentations or cells in the paper to provide either the randomly disposed portions as shown in FIG. 1 or the measured and specifically placed portion as is illustrated and described in conjunction with FIG. 2.

FIG. 4 shows schematically a portion of the cells such as shown at 54, 56 and 58 on a plan view basis and as illustrated, the cells are interconnected as shown at 55 and 57. It is not required that all of the cells be interconnected but it is required that the cells be interconnected so as to provide a continuous magnetic recording medium that can receive the information desired.

As is further illustrated in FIG. 3 the cells receive a magnetizable material as illustrated at 68 through 80 which forms the magnetic recording medium. The magnetizable material is retained internally within the cells and thus, the magnetic recording medium does not extend beyond the upper surface 82 of the base layer 52 of the paper stock. An upper layer of paper 84 is positioned upon the upper surface 82 of the paper stock 52 and functions to cover and protect the magnetizable material as shown at 68 through 80 which is contained within the cells. The layer of paper 84 may be secured to the base layer 52 in any manner known to the art, such as by an appropriate adhesive. The magnetizable material may be any material capable of functioning as a magnetic recording medium such as a ferromagnetic powder and may contain, if desired, additional elements which will render the magnetizable material more stable and capable of receiving and maintaining recorded information. The ferromagnetic metal powders may for example, contain particles of cobalt, aluminum, or yttrium. The ferromagnetic metal powders may be dispersed in a binder which can be applied to the upper surface 82 of the base layer 52 in which the cells have been formed to receive the magnetizable material. The binder may contain an appropriate adhesive which may be cured in manners well known to the prior art to secure the magnetizable material in place within the cells formed in the upper surface 82 of the base layer 52 of the paper stock. Examples of a binder which may be used are a polyurethane resin, an acrylic resin, a cellulose resin, or a vinyl chloride resin.

In addition to the formation of the magnetic recording medium as above described, the magnetizable particles may also be held in place during manufacture of the paper stock by applying the particles in a layer along the upper surface 82 of the paper stock 52 while at the same time applying a magnetic field beneath the paper layer 52 opposite the cells which magnetic field will attract the magnetizable particles and hold them in place until the layer 84 of paper has been put in place and secured to the upper surface 82 of the paper layer 52. Although alternative ways of applying the magnetizable material to the paper surface are disclosed, it is intended to include any other method known to the art for impregnating the paper with the magnetizable material. It will be recognized by one skilled in the art that in either instance, the particles of magnetizable material must be placed on the paper during the paper manufacturing process in a manner such that they provide either the measured and specifically placed portion as illustrated in FIG. 2 or the randomly disposed portions as shown in FIG. 1 of the magnetic recording medium.

By reference now, more particularly to FIG. 5, there is illustrated an envelope 86 constructed in accordance with the principles of the present invention which includes a magnetic recording medium 88 which extends up to the lower edge 90 of the flap 92. The magnetic recording medium may also extend around the back flap and upwardly and over to the outside of the flap as illustrated at 94. Appropriate information may be recorded in the magnetic recording medium as it overlaps between the flap 92 and the body 96 of the envelope 86. The recorded information in this overlap area may be such that complimentary bits of recorded information appear on the flap and on the body in the overlapped region of the recording medium. When the envelope flap 92 is opened and the two complimentary portions of the recording medium are displaced one from the other, the complimentary recorded data is destroyed. As a result, if a recipient of the envelope places the same on a magnetic read head before opening the envelope discovers that the data in the region shown at 94 in FIG. 5 does not provide the appropriate discernable information, that is, nothing is read, then this is the indication to the recipient that the integrity of the envelope has been destroyed by an unauthorized opening of the envelope. As an alternative to this, there may be a visual indication that the envelope has been tampered with. Such visual indication may be the appearance of words such as “open” or a specific color that was not otherwise to be upon the face of the envelope.

There has thus been disclosed a paper envelope containing a magnetic recording medium extending over at least a portion thereof which recording medium may be disposed in a randomly occurring manner or in a measured and specifically placed manner.

What is claimed is:

1. A paper stock envelope having a body portion having an interior and a flap foldable over the body portion to effect closure of the interior of said envelope, comprising:
a magnetic recording medium extending over at least a portion of said envelope, said magnetic recording medium being retained within a plurality of interconnected depressions, indentations or cells formed as an integral part of the paper forming said envelope.

2. The envelope of claim 1 which further includes an additional sheet of paper with said magnetic recording medium sandwiched between said additional sheet of paper and said cells.

3. The envelope of claim 2 wherein said magnetic recording medium is contained in a plurality of discrete portions randomly disposed on said envelope.

4. The envelope of claim 3 wherein said plurality of discrete portions are disposed on said body.

5. The envelope of claim 3 wherein said plurality of discrete portions are disposed on said flap.

6. The envelope of claim 3 wherein said plurality of discrete portions are disposed on said body and said flap.

7. The envelope of claim 2 wherein said magnetic recording medium is contained in at least one measured and specifically placed portion of said envelope.

8. The envelope of claim 7 wherein said measured and specifically placed portion comprises a continuous strip of magnetic recording medium extending along said body and said flap.

9. The envelope of claim 7 wherein said measured and specifically placed portion comprises a continuous strip of magnetic recording medium extending along said flap.

10. The envelope of claim 7 wherein said measured and specifically placed portion comprises a continuous strip of magnetic recording medium extending along said body and flap.

11. An envelope as defined in claim 1 wherein said magnetic recording medium is overlappingly disposed on said body and said flap whereby recorded material in said overlap region is altered when said flap is opened.

12. An envelope as defined in claim 2 wherein said magnetic recording medium is overlappingly disposed on said body and said flap whereby recorded material in said overlap region is altered when said flap is opened.

13. The envelope of claim 7 wherein said measured and specifically placed portion comprises recording medium in a broken strip extending along said body.

14. The envelope of claim 7 wherein said measured and specifically placed portion comprises recording medium in a broken strip extending along said flap.

15. The envelope of claim 7 wherein said measured and specifically placed portion comprises recording medium in a broken strip extending along said body and flap.
